(19) United States
(12) Patent Application Publication
(10) Pub. No.: US 2022/0405671 A1
(43) Pub. Date: Dec. 22, 2022

(54) SYSTEM AND METHOD FOR OPTIMIZING A PROPOSED DWELLING

(71) Applicant: MODERN MARKET TECHNOLOGIES, INC., Chula Vista, CA (US)

(72) Inventors: Jose FRAUSTO, Chula Vista, CA (US); Jose LUQUIN, Chula Vista, CA (US)

(21) Appl. No.: 17/843,279

(22) Filed: Jun. 17, 2022

Related U.S. Application Data
(60) Provisional application No. 63/212,780, filed on Jun. 21, 2021.

(51) Int. Cl. G06Q 10/06; G06Q 50/16

(52) U.S. Cl. CPC G06Q 10/06315; G06Q 50/165

(57) ABSTRACT

A system and method for determining and optimal plan and specification for a proposed residential dwelling by minimizing the net cost of the dwelling to the homeowner based on a cost to build the dwelling and an estimated rental income for the dwelling. Rental income is estimated as a function of a rental history of an existing dwelling and a degree of similarity between the existing dwelling and the proposed dwelling. The parameters of the plan and specification of the proposed dwelling may be selected or obtained from a combination of user inputs, default settings, and system constraints. A three-dimensional visualization of the proposed dwelling may be integrated and rendered with a three-dimensional representation of the lot.

### FIELD

The present disclosure relates to determining a plan and a specification for a residential dwelling, and more particularly, to a system and method for determining an optimal plan and an optimal specification for a proposed residential dwelling.

### BACKGROUND

As used herein, a residential dwelling is an attached or detached single- or small multi-family home. A dwelling may be situated on a lot alone or it may share a lot with another residential structure. A dwelling that is situated on a lot with no other residential structures may be a primary residence, and a dwelling that shares a lot may be a primary or secondary residence and it may be attached to or located at least partly within another residential structure on the lot. A dwelling that is a secondary residence may be called an accessory dwelling unit (ADU), an accessory apartment, a secondary suite, an in-law, a mother-in-law unit, a granny flat, or a carriage house. A dwelling generally has its own kitchen, living area, bathroom, and private entrance.

A homeowner may want to build or install a dwelling to provide additional living space for an extended family or to rent or lease the dwelling for income. As used herein, a “homeowner” is a person or organization with authority to have a dwelling situated on a lot, either as the only residential structure or in addition to an existing residential structure or structures. As used herein, the terms “rent” and “lease” describe a payment in exchange for living accommodations for any duration. A dwelling may be built, fabricated, constructed, created, placed, located, added, or situated on a lot or at least partly within another residential structure, depending on the type of dwelling that is considered. These terms (build, fabricate, etc.) may be used interchangeably throughout this disclosure with regards to dwellings of any type. As used herein, a “lot” is a parcel of land.

A challenge that a homeowner faces when considering a dwelling is to choose or create the plan and specification for the dwelling that will be situated on a lot. A “dwelling plan” may describe a dwelling at varying levels of detail, for example: (i) a minimally detailed description such as “a 300 sq. ft. detached dwelling;” (ii) an moderately detailed floorplan or layout such as a drawing showing an 6′×8′ kitchen adjacent to a 8′×10′ bedroom and a 5′x7′ bathroom; or (iii) a highly detailed construction plan such as a blueprint showing all framing and all electrical, plumbing, and HVAC systems. There are many types of dwellings, such as detached from another residential structure, attached to another residential structure, and partly or entirely within another residential structure (“interior” to another residential structure). A dwelling within another residential structure may be located practically anywhere therein, for example in a basement, in or above a garage, on an upper floor, in an attic, and so on.

After dwelling plan has been chosen, the homeowner may specify the fixtures and building materials for the dwelling, such as ceiling fans, fireplaces, permanent air conditioners, certain outdoor plants, vinyl siding, hardwood floors, stone counter tops, and so on. A “dwelling specification” may comprise descriptions of fixtures and building materials that are compatible with a given dwelling plan. For example, a dwelling specification describing a permanent air conditioner may be compatible with a detached dwelling plan but not with an interior dwelling plan. In some cases, the homeowner may choose one or more “specification parameters” first and then choose a dwelling plan that is compatible with the parameters. Alternatively or additionally, a dwelling plan may itself include specification parameters, for example, suggested building materials such as architectural asphalt shingles or cedar siding. As used herein, the term “parameter” may describe an element, feature, criterion, or detail of a dwelling plan and an element, feature, criterion, or detail of a dwelling specification.

Determining a dwelling plan and a dwelling specification plays a major role in determining the cost to build a dwelling, which ultimately translates into the appearance, functionality, and purchase price (or acquisition cost) of the dwelling to the homeowner. Typically, a homeowner considers his financial situation and determines a budget for a proposed dwelling, which in turn helps to determine the type, size, fixtures, and building materials of the dwelling. In the case of a homeowner who wants to rent a dwelling to another, an expected rental income (and associated expenses) may also be factored into the budget to determine a net cost to the homeowner. A sophisticated homeowner may even enlist the help of a real estate agent who might provide market-rent information.

While market-rent information may suggest the going rate for comparable rental properties within a given area, it may not provide information that is specific to a homeowner and to one or more proposed dwellings under consideration that enables minimization of a net cost of the dwelling to the homeowner. Further, current methods of determining a dwelling plan and a dwelling specification may not enable the homeowner to view a visualization of a proposed dwelling, that is generated from the dwelling plan and the dwelling specification, as it would appear situated on the lot. Further still, current methods of visualizing a proposed dwelling may not enable the homeowner to visualize in real-time the selection or modification of various parameters of the proposed dwelling while simultaneously optimizing net cost to the homeowner.

The present invention solves these and other problems in the prior art.

### SUMMARY

The several embodiments provide a system and method to enable a homeowner, who wants to situate a dwelling on a lot for renting to another, to determine a “best” dwelling in terms of minimizing a net cost of the dwelling. A plurality of proposed dwellings are generated, each according to a respective dwelling plan and conforming to a respective dwelling specification. A net cost of each proposed dwelling to the homeowner is computed by subtracting an estimated rental income of each respective proposed dwelling from a determined purchase price of the same respective proposed dwelling. A rental income of each proposed dwelling is estimated based on rental history of at least one existing dwelling that is similar to a respective one of the proposed dwellings, and a purchase price for each proposed dwelling is determined based on the cost to build the respective proposed dwelling. In some embodiments, a 3D visualization of one or more proposed dwellings (such as dwelling with minimum or near-minimum cost) may be rendered and superimposed on a 3D representation of the lot.

There are many objects of the several embodiments, including: determining whether a dwelling plan satisfies the building requirements for a lot; determining whether a given dwelling specification is compatible with a given dwelling plan; resolving redundant parameters that may be included in a given dwelling plan and a given dwelling specification; providing missing parameters that should be included in a given dwelling plan or a given dwelling specification; generating a proposed dwelling according to a given dwelling plan and conforming to a given dwelling specification; determining which of a plurality of existing dwellings is most similar to a given proposed dwelling; determining a rent of an existing dwelling based on its rental history; rendering a 3D visualization of a proposed dwelling; and superimposing a 3D-rendered proposed dwelling on a 3D representation of a lot.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1A shows a flowchart for determining an optimal dwelling according to a given dwelling plan and conforming to a given dwelling specification, and FIGS. 1B-1D show zoomed-in portions of the flowchart shown in FIG. 1A segmented along the vertical dashed-dotted lines.

FIGS. 2A-2C depict a dwelling plan at varying levels of abstraction.

FIGS. 3A-3C depict a dwelling specification at varying levels of abstraction.

FIG. 4 depicts an exemplary generation of a proposed dwelling from a dwelling plan and a dwelling specification.

FIG. 5 depicts some inputs that may be used to determine a purchase price of a proposed dwelling.

FIG. 6 illustrates an exemplary technique for determining which existing dwelling is most similar to a given proposed dwelling.

FIG. 7 illustrates an exemplary geographic area that includes a lot where a dwelling may be situated and a plurality of existing dwellings each having a rental history.

FIGS. 8A-8B each depict a rendered dwelling integrated with a rendered lot.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions, or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise.

The following numerals are used to describe various features of the embodiments.
10 flowchart
50 obtain-scan step
52a lidar scan
52b image capture
60 lot representation
100 obtain-plan step
110 dwelling plan
120a default selection
120b user selection
120c system selection
130 plan-verification step
140 building requirements
150 iterate-plan step
200 obtain-specification step
210 dwelling specification
220a default selection
220b user selection
220c system selection
230 specification-verification step
250 iterate-specification step
300 generate-proposed step
310 proposed dwelling
310x optimal dwelling (corresponding to minimum net cost)
310y suboptimal dwelling (corresponding to maximum net cost)
320 lot
330 existing dwelling
330a/b/c specific existing dwelling
340 parameter weight
350 geographic area
360 match value
400 build-quotation step
410 dwelling purchase price
420 construction cost
430 credit score and finance charges
500 rent-estimation step
510 dwelling rental income
520 rental history
530 degree of similarity
530a/b/c specific degree of similarity
600 cost-accounting step
610 net cost
610x minimum net cost
610y maximum net cost
700 select-optimal step
800 render-optimal step
810 rendered dwelling

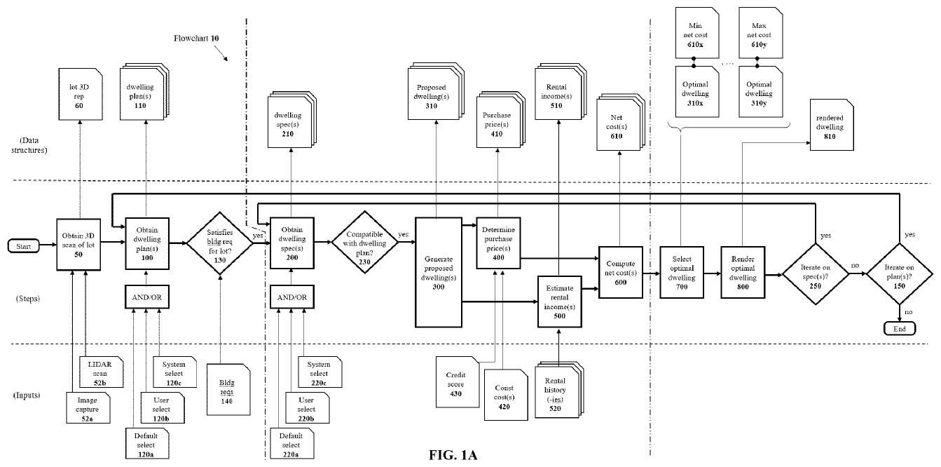

FIGS. 1A-1D show a flowchart 10 of an exemplary embodiment where an optimal dwelling 310x (upper right) is determined to be optimal in terms of having the minimum net cost 610x (also upper right) from a plurality of proposed dwellings 310 each having a different dwelling plan 110 and/or a different dwelling specification 210. As used herein, a “proposed dwelling” is a dataset or computer-readable description of a dwelling that comprises a dwelling plan and a compatible dwelling specification. The top portion of the flowchart 10 shown above the upper horizontal dashed line indicates data structures; the middle portion of the flowchart 10 between the upper and lower horizontal dashed lines indicates steps; and the bottom portion of the flowchart 10 below the lower horizontal dashed line indicates inputs. For brevity, not all inputs are shown in FIG. 1A. The ordering of steps in the flowchart 10 may be altered in different embodiments. For example, the obtain-plan step 100 and the obtain-specification step 200 may be swapped, or the render-optimal step 800 may be placed immediately following the generate-proposed step 300 instead of immediately after the select-optimal step 700. Such variations may become evident throughout this disclosure.

The flowchart 10 begins with an obtain-scan step 50 where a three-dimensional lot representation 60 of a lot 320 (not shown in FIG. 1A) is obtained. The lot 320 is the location at which a proposed dwelling 310 may be situated. The lot representation 60 may have been captured using any suitable technique, for example aerial or ground-based image capture 52a and aerial or ground-based lidar scan 52b. Aerial image capture 52a and aerial lidar scan 52b may be captured with the aid of any suitable aircraft or spacecraft, for example drone, airplane, or satellite.

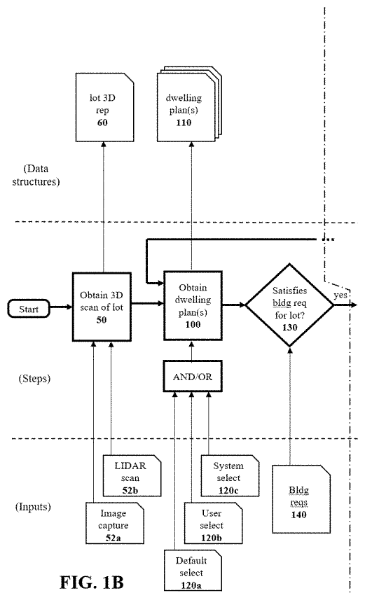

Once the lot representation 60 has been obtained, one or more dwelling plans 110 are obtained in an obtain-plan step 100. A dwelling plan 110 may be a high-level description of a dwelling, for example “a 300 sq. ft. detached dwelling,” or it may comprise detailed construction plans for a dwelling. FIGS. 2A-2C show an exemplary dwelling plan 110 at varying levels of abstraction. A dwelling plan 110 may be obtained via default selection 120a, via user selection 120b, and/or via system selection 120c. To be clear, the parameters of a given dwelling plan 110 may be obtained from a single input source or they may be obtained from a plurality of input sources. For example, a dwelling plan 110 may comprise a default selection 120a for all parameters except that the size of the dwelling is obtained via user selection 120b. As another example, a user may input a desire for a detached dwelling to a system, and the system may then obtain some or all dwelling plans 110 for only detached dwellings from a database. As used herein, the term “system” may refer to a system comprising a non-transitory computer-readable medium comprising instructions for causing a computing environment to perform the process depicted by the flowchart 10 or to perform a related or alternate embodiment. As used herein, the term “user” may refer to a person such as a homeowner.

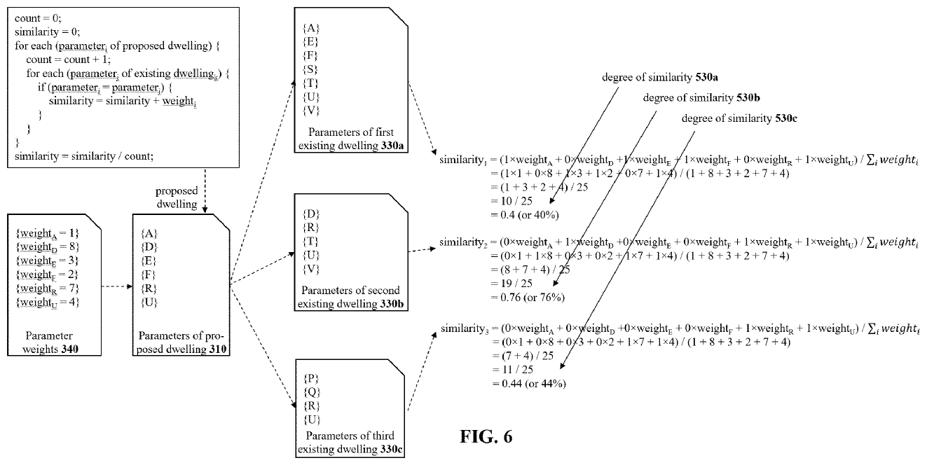

System selection 120c of a dwelling plan 110 may be accomplished using several methods. For example, a system performing the process depicted by the flowchart 10 may determine an existing dwelling 330b within a specified geographic area 350, as shown in FIG. 7, that has the highest rental income, and the system may then obtain or generate a dwelling plan 110 that mimics as closely as possible the plan of that existing dwelling 330b. As another example, the system may determine the most common parameters among the existing dwellings 330 within a specified geographic area 350 and then obtain (or generate) a dwelling plan 110 that includes as many of those parameters as possible. The geographic area 350 may, but need not, include the lot 320 where the proposed dwelling 310 may be situated.

A plan-verification step 130 determines whether the obtained dwelling plan 110 satisfies building requirements 140 for the lot 320 on which a proposed dwelling 310 may be situated. The building requirements 140 may comprise zoning information, building setback information, minimum and maximum building footprints, and so on. The building requirements 140 may be obtained automatically by query to a server either directly or through an application-program interface (API), or the building requirements 140 may be entered manually by a user. An example of satisfying a building requirement 140 may be when a dwelling plan indicates a building footprint that is within the minimum and maximum allowable footprint. An example of not satisfying a building requirement 140 may be when a dwelling plan indicates an exterior dwelling that violates a no-outbuildings zoning ordinance.

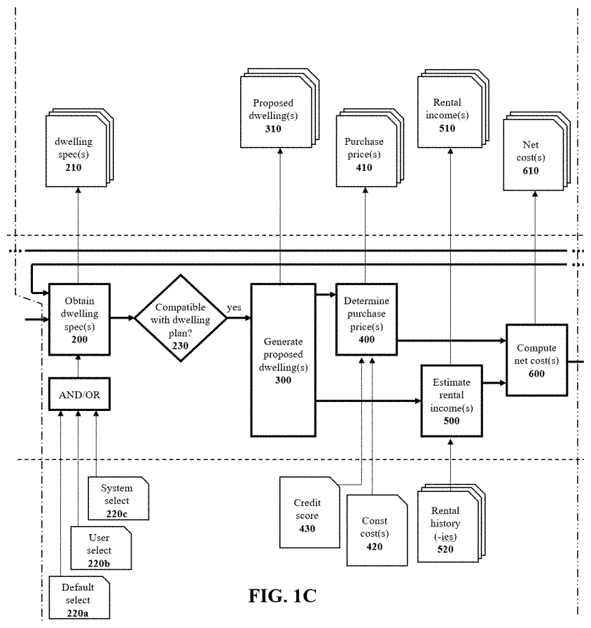

If the dwelling plan 110 satisfies the building requirements 140, then one or more dwelling specifications 210 may be obtained in the obtain-specification step 200. A dwelling specification 210 describes one or more parameters of a dwelling that may not be described in a dwelling plan 110, for example fixtures and building materials of a dwelling. Fixtures of a dwelling may include things like ceiling fans, fireplaces, air conditioners, certain outdoor plants, and so on. Building materials of a dwelling may include things like vinyl siding, hardwood floors, granite counter tops, and so on. FIGS. 3A-3C show an exemplary dwelling specification 210 at varying levels of abstraction. If certain parameters are included in both the dwelling plan 110 and the dwelling specification 210, then one of each such redundant parameter may take precedence, for example, a parameter included the dwelling specification 210 may override a parameter also included in the dwelling plan 110. If a dwelling plan 110 includes all parameters that would normally be included in a dwelling specification 210, then the dwelling specification 210 might be absent of parameters.

A dwelling specification 210 may be obtained via default selection 220a, via user selection 220b, and/or via system selection 220c. To be clear, the parameters of a given dwelling specification 210 may be obtained from a single input source or they may be obtained from a plurality of input sources. For example, a dwelling specification 210 may comprise a default selection 220a for all parameters except that the interior flooring parameter is obtained via user selection 220b.

System selection 220c of a dwelling specification 210 may be accomplished using several methods. For example, the system may determine an existing dwelling 330b within a specified geographic area 350, as shown in FIG. 7, that has the highest rental income, and the system may then obtain or generate a dwelling specification 210 that mimics as closely as possible the specification of that existing dwelling 330b. As another example, the system may determine the most common parameters among the existing dwellings 330 within a specified geographic area 350 and then obtain or generate a dwelling specification 210 that includes as many of those parameters as possible. The geographic area 350 may, but need not, include the lot 320 where the proposed dwelling 310 may be situated.

Note that the embodiment illustrated in FIG. 1A provides for serial, parallel, or hybrid processing of dwelling plans 110 and dwelling specifications 210. Serial processing may require more computation time than parallel processing, but it may require fewer computational resources. Hybrid processing represents a tradeoff between computation time and computational resources.

In serial processing of dwelling plans 110 and dwelling specifications 210, one dwelling plan 110 may be obtained per pass of the outer loop as determined by the iterate-plan step 150 and one dwelling specification may be obtained per pass of the inner loop as determined by the iterate-specification step 250. Each pass through the combined outer-inner loops may increment by one the number of proposed dwellings 310 from which to select an optimal dwelling 310x in the select-optimal step 700.

In parallel processing of dwelling plans 110 and dwelling specifications 210, a plurality of dwelling plans 110 may be obtained in a single pass of the outer loop and a plurality of dwelling specifications 210 may be obtained in a single pass of the inner loop. An optimal dwelling 310x may be selected in the select-optimal step 700 from among a plurality of proposed dwellings 310.

Hybrid processing is a combination of serial and parallel processing, where during each of one or more iterations, either (i) one dwelling plan 110 is obtained and a plurality of dwelling specifications 210 are obtained, or (ii) a plurality of dwelling plans 110 are obtained and one dwelling specification 210 is obtained. Each iteration of hybrid processing may increment by at least two the number of proposed dwellings from which to select an optimal dwelling 310x in the select-optimal step 700. For simplicity, the descriptions that follows are based on serial processing.

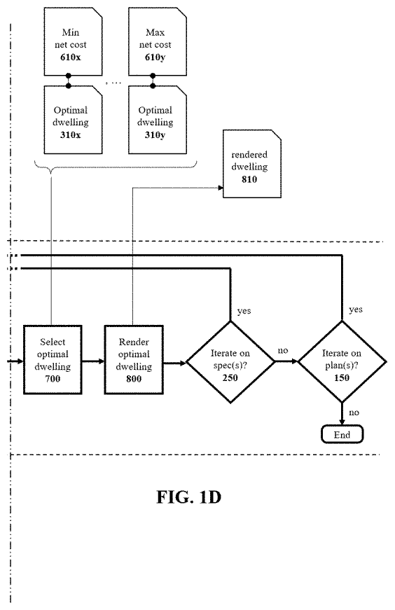

Once a dwelling plan 110 and a dwelling specification 210 have been obtained, a proposed dwelling 310 can be dynamically generated in the generate-proposed step 300. The proposed dwelling 310 may comprise all information necessary to build and/or situate the dwelling on the lot 320. The proposed dwelling 310 is generated in accordance with the dwelling plan 110 and in conformance with the dwelling specification 210. FIG. 4 depicts a proposed dwelling 310 as including n parameters from the dwelling plan 110 and m parameters from the dwelling specification 210, where in this case no parameter 1 through n of the dwelling plan 110 is redundant with any parameter 1 through m of the dwelling specification 210. For example, the proposed dwelling 310 may describe a 1-bed, 1-bath dwelling with a footprint of 300 sq. ft. (from the dwelling plan 110) having 0.040 in. thick double lap vinyl and 0.75 in. thick by 5 in. wide prefinished oak floors throughout (from the dwelling specification 210). The proposed dwelling 310 may be provided as an input to both the build-quotation step 400 and the rent-estimation step 500.

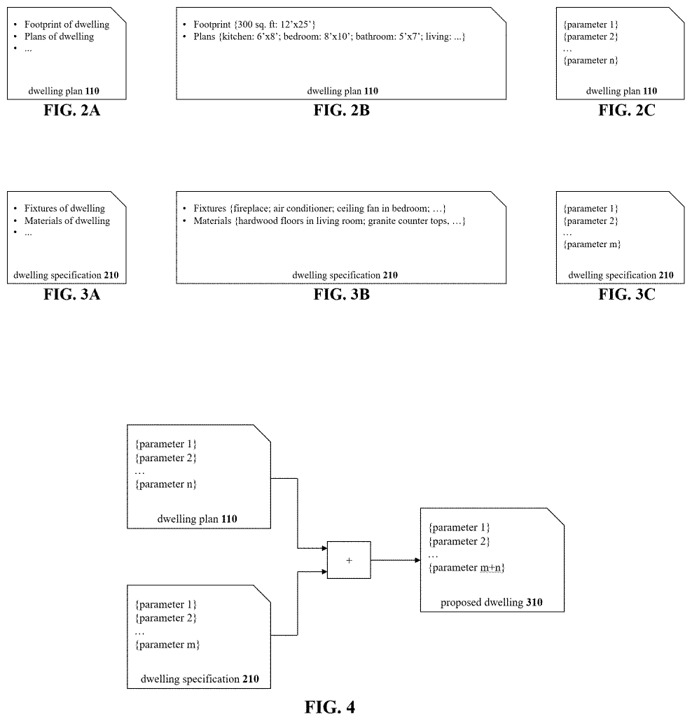

In the build-quotation step 400, an overall dwelling purchase price 410 for the proposed dwelling 310 may be determined using any suitable technique. For example, as shown in FIG. 5, the dwelling purchase price 410 may be determined by adding up the construction costs 420 for the proposed dwelling 310, which may include: (i) building materials and components; (ii) labor and overhead; (iii) equipment and miscellaneous expenses; and (iv) permits and insurance. Alternatively, the construction cost 420 may be obtained as a bid from a third-party contractor and/or a third-party lender. The dwelling purchase price 410 may be represented as a lump-sum amount or as periodic payments. If a homeowner intends to purchase the proposed dwelling 310 using financing, then the dwelling purchase price 410 may also account for a personal credit score and finance charges 430.

In the rent-estimation step 500, a dwelling rental income 510 may be estimated based on the rental history 520 of an existing dwelling 330 that is most similar in plan and specification to the proposed dwelling 310. The rent-estimation step 500 relies on quantifying a degree of similarity 530 between a proposed dwelling 310 and an existing dwelling 330. One way to quantify the degree of similarity 530 is to count how many parameters (or features) of the proposed dwelling 310 match to parameters (or features) of the existing dwelling 330 and divide by the total number of parameters of the proposed dwelling. As used herein, the term “features” may be used for parameters extracted from an image such as a layout or blueprint representation of a dwelling plan 110.

There are many techniques and heuristics known in the art for quantifying matching between arbitrarily formatted parameters (e.g., strings of text or images) and determining a degree of similarity 530. Natural language processing (NLP) may be used for matching parameters represented as strings, such as matching based on syntactic, semantic, cosine, and Jaccard similarity. When a dwelling plan 110 or an existing dwelling 330 is represented by a graphical layout or blueprint, image-processing feature extraction may be used to extract relevant parameters for comparison and subsequent determination of a match value 360. Any suitable image processing techniques and heuristics may be used, including those of pattern recognition, image segmentation, image enhancement, feature extraction, feature classification, and so on. Parameters determined by image-processing feature extraction may be compared graphically or converted to strings to be compared textually. For example, a match value 360 for building footprints extracted from blueprints could be determined by graphically comparing a scaled image of the footprint of the proposed dwelling 310 with an identically scaled image of the footprint of the existing dwelling 330, or by comparing text descriptions of strings that have been generated from the respective blueprints.

Matching may be binary (true/false) or nonbinary (degree). For example, a parameter of “wood floors throughout” indicated by a proposed dwelling 310 and an existing dwelling 330 having “wood floors in the living room” could have a binary match value 360 of zero (false) but a nonbinary match value 360 of 60%. Counting of nonbinary matches could be accomplished by counting any match above a specified matching threshold and not counting any match below the matching threshold. Alternatively, each parameter could be assigned a parameter weight 340 that is multiplied by the binary or nonbinary match value 360 prior to summation.

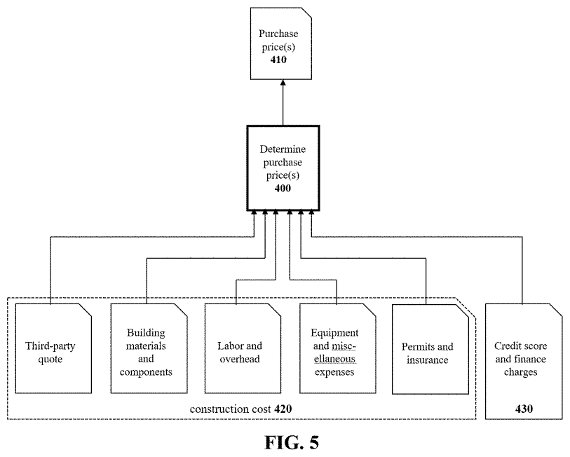

A simple binary parameter-matching example with parameter weights 340 is illustrated in FIG. 6. The proposed dwelling 310 comprises six parameters {A, D, E, F, R, and U} each having a corresponding parameter weight 340 as shown by “weight_{A},” weight_{D},” and so on. Four parameters match between the first existing dwelling 330a and the proposed dwelling 310, which results in a degree of similarity 530a of (1×1+0×8+1×3+1×2+0×7+1×4)/25=0.4 (or 40%). Three parameters match between the second existing dwelling 330b and the proposed dwelling 310, which results in a degree of similarity 530b of (0×1+1×8+0×3+0×2+1×7+1×4)/25=0.76 (or 76%). Finally, two parameters match between the third existing dwelling 330c and the proposed dwelling 310, which results in a degree of similarity 530c of (0×1+0×8+0×3+0×2+1×7+1×4)/25=0.44 (or 44%). In this example, the second existing dwelling 330b has the greatest degree of similarity 530 to the proposed dwelling 310 even though the first existing dwelling 330a matches more parameters. Thus, the second existing dwelling 330b is determined to be most similar in plan and specification to the proposed dwelling 310 among all considered existing dwellings 330a, 330b, and 330c.

The rental income 510 may be determined from the rental history 520 using any suitable technique, such as a weighted average of the most recent rent payment (or an average of recent rent payments) indicated by the rental history 520 of an existing dwelling 330 that is most similar to the proposed dwelling 310 and a market rent. For example, using greatest degree of similarity 530b shown in FIG. 6, using the rent payment indicated by the respective rental history 520b shown in FIG. 7, and using a market rent of $1000, the dwelling rental income 510 may be computed as 0.76×$1200+(1−0.76)×$1000=$1152.

The rental income 510 may further account for projected future rent payments based on trends indicated by the rental history 520 and/or by other market information. The rent-estimation step 500 may additionally account for one or more of: (i) the location or neighborhood of the existing dwelling 330, (ii) the location or neighborhood of the lot 320, and (iii) a distance between the existing dwelling 330 and the lot 320. For example, the rent corresponding to a first existing dwelling 330a that is closer to the lot 320 than a second existing dwelling 330b may be weighted differently than the rent corresponding to the second existing dwelling 330b, where each respective weighting factor may be a function of a distance between the lot 320 and the respective existing dwelling 330.

After a dwelling purchase price 410 and a dwelling rental income 510 have been determined for each proposed dwelling 310, a net cost 610 for each proposed dwelling 310 is computed in the cost-accounting step 600 by subtracting the respective dwelling rental income 510 from the respective dwelling purchase price 410.

In purely serial processing, when the select-optimal step 700 is reached during the first iteration, there has only been one proposed dwelling 310 generated and thus only one net cost 610. Thus, determining an optimal dwelling 310x—which is the proposed dwelling 310 having the lowest net cost 610x—is straight forward. During a subsequent serial iteration (or during any hybrid or parallel iteration), a plurality of proposed dwellings 310 would have been generated and a respective plurality of net costs 610 would have been computed. In such case, an optimal dwelling 310x may be determined by sorting the proposed dwellings 310 in ascending order of net cost 610 and selecting the proposed dwelling 310 at the top of the list (or sorting the proposed dwellings 310 in descending order of net cost 610 and selecting the proposed dwelling 310 at the bottom of the list). Note that instead of computing a “net cost” in the cost-accounting step 600, a “net revenue” could be computed by reversing the subtrahend and minuend of the “net cost” difference computation. In such case, the select-optimal step 700 would select an optimal dwelling 310x as one having a maximum net revenue. There are many suitable algorithms and heuristics known in the art for selecting extreme values from a list, set, or group, which for brevity are not detailed herein.

In serial (or hybrid) processing, a determination is made in the iterate-specification step 250 whether to proceed to the iterate-plan step 150 or to return to the obtain-specification step 200 for one or more additional inner-loop iterations. Such determination may be based on user input and/or by the system. For example, the system may be configured to iterate for a fixed number of iterations and/or until a computed minimum net cost 610x is below a specified threshold. Similarly, in serial (or hybrid) processing, a determination is made in the iterate-plan step 150 whether to terminate the process or to return to the obtain-plan step 100 for one or more additional outer-loop iterations. As described above, the system may be configured to iterate for a fixed number of iterations and/or until a computed minimum net cost 610x is below a specified threshold. When terminated, the process has determined an optimal dwelling 310x that has a minimum net cost 610x from among all proposed dwellings 310 considered.

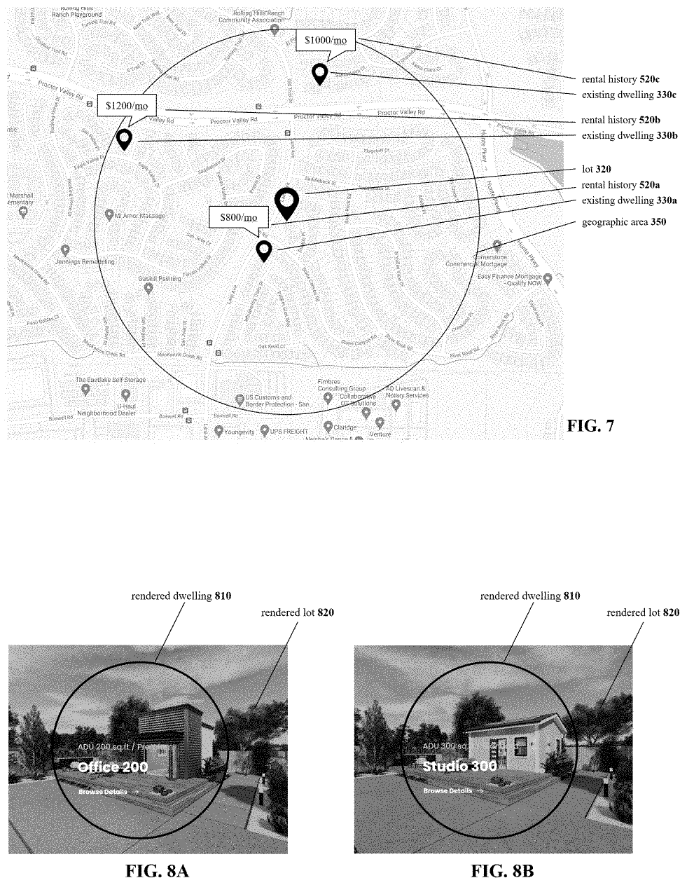

Once an optimal dwelling 310x has been determined, a render-optimal step 800 may generate a rendered dwelling 810 by integrating together and rendering the lot representation 60 with the optimal dwelling 310x. The rendered dwelling 810 is a visualization that may be presented to a user by any suitable immersive or non-immersive experience, for example as 3D video displayed on a computer screen or virtual reality displayed on head-worn goggles. Any suitable techniques and associated 3D (and 2D) rendering engines may be used to generate the rendered dwelling 810. Exemplary rendered dwellings 810 are shown in FIGS. 8A-8B integrated with a rendered lot 820.

Although the embodiment depicted by FIG. 1A performs the render-optimal step 800 for one proposed dwelling 310 per iteration of the inner loop of the flowchart 10, an alternate embodiment may perform the render-optimal step 800 for a plurality of proposed dwellings 310—or for none of the proposed dwellings 310—depending on system configuration and user preference. For example, the render-optimal step 800 may be placed immediately following the generate-proposed step 300 instead of immediately after the select-optimal step 700, in which case the system performing the process may generate a rendered dwelling 810 for every newly proposed dwelling 310. While this may be computationally intensive, it may be beneficial to enable a user to visualize every proposed dwelling 310. Indeed, a rendered dwelling 810 may be generated dynamically while the user selects various parameters of a given dwelling specification 210. Moreover, the purchase price 410, the rental income 510, and the net income 610 could be generated dynamically as a user selects or modifies a dwelling plan 110 or selects or modifies the various parameters of a dwelling specification 210. In this manner, the user may experience an immersive optimization of a proposed dwelling 310 in real-time.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A method, performed by instructions executed on a computing device, of determining an optimal residential dwelling from a plurality of dynamically generated proposed dwellings, comprising:
obtaining data representing one or more plans for a dwelling, the one or more plans each satisfying building requirements of a lot;
obtaining data representing one or more specifications, each specification compatible with at least a respective one of the plans;
generating a plurality of proposed dwellings each according to a respective one of the plans and conforming to a respective one of the specifications;
determining a purchase price of each proposed dwelling based on a construction cost thereof;
estimating a rental income of each proposed dwelling as a function of a rental history of a respective existing dwelling and a degree of similarity between the respective existing dwelling and the respective proposed dwelling;
determining a net cost of each proposed dwelling as a function of a difference between the respective rental income and the respective purchase price; and
determining an optimal dwelling as one of the proposed dwellings having a minimum net cost.

2. The method of claim 1 further comprising:
obtaining a 3D representation of the lot having been captured by aerial or ground-based imagery or scanned by aerial or ground-based lidar; and
integrating together and rendering the 3D representation of the lot and at least one proposed dwelling.

3. The method of claim 2 wherein the at least one proposed dwelling is the optimal dwelling.

4. The method of claim 1 wherein each purchase price is further based on at least one of a personal credit score and a finance charge.

5. The method of claim 1 wherein each degree of similarity is a function of a count of parameters that each have a match value above a specified threshold.

6. The method of claim 5 wherein each match value is determined by at least one of natural language processing (NLP) and image processing.

7. The method of claim 1 wherein each rental income is a weighted average of a rent indicated by the respective rental history, weighted by the respective degree of similarity, and a market rent, weighted by one minus the same respective degree of similarity.

8. The method of claim 1 wherein a rent indicated by each rental history is weighted by a function of distance between the lot and the respective existing dwelling.

9. The method of claim 1 wherein the building requirements are obtained by query to a server or database directly or through an application-program interface (API).

10. A non-transitory computer-readable medium, comprising instructions for causing a computing environment to perform a method of determining an optimal residential dwelling from a plurality of dynamically generated proposed dwellings, the method comprising:
obtaining data representing one or more plans for a dwelling, the one or more plans each satisfying building requirements of a lot;
obtaining data representing one or more specifications, each specification compatible with at least a respective one of the plans;
generating a plurality of proposed dwellings each according to a respective one of the plans and conforming to a respective one of the specifications;
determining a purchase price of each proposed dwelling based on a construction cost thereof;
estimating a rental income of each proposed dwelling as a function of a rental history of a respective existing dwelling and a degree of similarity between the respective existing dwelling and the respective proposed dwelling;
determining a net cost of each proposed dwelling as a function of a difference between the respective rental income and the respective purchase price; and
determining an optimal dwelling as one of the proposed dwellings having a minimum net cost.

11. The medium of claim 10 wherein the method further comprises:
obtaining a 3D representation of the lot having been captured by aerial or ground-based imagery or scanned by aerial or ground-based lidar; and
integrating together and rendering the 3D representation of the lot and at least one proposed dwelling.

12. The medium of claim 11 wherein the at least one proposed dwelling is the optimal dwelling.

13. The medium of claim 10 wherein each purchase price is further based on at least one of a personal credit score and a finance charge.

14. The medium of claim 10 wherein each degree of similarity is a function of a count of parameters that each have a match value above a specified threshold.

15. The medium of claim 14 wherein each match value is determined by at least one of natural language processing (NLP) and image processing.

16. The medium of claim 10 wherein each rental income is a weighted average of a rent indicated by the respective rental history, weighted by the respective degree of similarity, and a market rent, weighted by one minus the same respective degree of similarity.

17. The medium of claim 10 wherein a rent indicated by each rental history is weighted by a function of distance between the lot and the respective existing dwelling.

18. The medium of claim 10 wherein the building requirements are obtained by query to a server or database directly or through an application-program interface (API).
